(19) United States
(12) Patent Application Publication
(10) Pub. No.: US 2026/0307744 A1
(43) Pub. Date: Oct. 8, 2026

(54) AN INTERMODAL CONTAINER ATTACHMENT FOR REDUCING AERODYNAMIC DRAG

(71) Applicant: OXFORD INNOVATION PARTNERS (OXIP) LTD., Bicester, Oxfordshire (GB)

(72) Inventor: James DAULTON, Bicester, Oxfordshire (GB)

(21) Appl. No.: 19/478,997

(22) PCT Filed: Apr. 26, 2024
(86) PCT No.: PCT/GB2024/051101

§ 371 Date: Oct. 27, 2025

(30) Foreign Application Priority Data
Apr. 27, 2023 (GB) 2306270.6

(51) Int. Cl. B62D 35/00

(52) U.S. Cl. CPC B62D 35/001

(57) ABSTRACT

An intermodal container attachment for reducing drag of an intermodal container when coupled to a tractor unit. The intermodal container attachment comprises at least one aerodynamic panel and at least one attachment portion coupled to the at least one aerodynamic panel. The attachment portion is configured to reversibly couple to an intermodal container such that the at least one aerodynamic panel is configured to be arranged adjacent to a first surface of the intermodal container, the first surface of the intermodal container situated furthest away from the tractor unit. The aerodynamic panel is configured to be arranged at an acute angle relative to the first surface of the intermodal container when the attachment portion is coupled thereto. A skeletal trailer is also provided, comprising a chassis; and the intermodal container attachment, with the attachment coupled to its chassis.

### FIELD OF THE INVENTION

The present disclosure relates to an intermodal container attachment, in particular an intermodal container attachment for reducing drag of an intermodal container when coupled to a tractor unit.

### BACKGROUND

Intermodal containers, commonly referred to as shipping containers, are large, standardised cargo containers designed for intermodal freight transport, including shipping, rail, and road transportation, without unloading and reloading their cargo. Their rectangular, closed-box structure is designed for ease of stacking and storage to accommodate many thousands of intermodal containers on large container ships. However, the rectangular, closed-box structure is far from ideal for when the containers are then moved by road transport, such as trucks or lorries, or by rail. The rectangular, closed-box container is subject to high aerodynamic drag which reduces the fuel efficiency of the transporting vehicle.

The use of aerodynamic devices, such as boat tails, is known to reduce aerodynamic drag for semi-trailers. However, these are permanent fixtures, integrated to the cargo container of the semi-trailer. These are not suitable for use with intermodal containers.

### SUMMARY OF THE INVENTION

Aspects of the invention are as set out in the independent claims and optional features are set out in the dependent claims. Aspects of the invention may be provided in conjunction with each other and features of one aspect may be applied to other aspects.

An aspect of the invention relates to an intermodal container attachment for reducing drag of an intermodal container when coupled to a tractor unit. The intermodal container attachment comprises at least one aerodynamic panel and at least one attachment portion coupled to the at least one aerodynamic panel. The at least one attachment portion is configured to reversibly couple to an intermodal container such that the at least one aerodynamic panel is configured to be arranged adjacent to a first surface of the intermodal container, wherein the intermodal container is configured to couple a tractor unit, and wherein the first surface of the intermodal container is configured to be a surface of the intermodal container situated furthest away from the tractor unit. The at least one aerodynamic panel is configured to be arranged at an acute angle relative to the first surface of the intermodal container when the attachment portion is coupled to the intermodal container. This may be advantageous as, in use, the at least one aerodynamic panel will reduce drag on the container by providing a tapered surface relative to the intermodal container, in particular reducing drag in the proximity of the first surface of the container. The reduction in drag may improve the fuel economy of the vehicle transporting the container, which in turn lowers vehicle emissions. Furthermore, the at least one attachment portion may be advantageous to facilitate a reversible coupling to an intermodal container. This is particularly advantageous in the case of intermodal containers which are built for intermodal freight transport, including ship, rail, and road. In mass freight transport, such as shipping, the intermodal container attachment may be removed to allow the container to be tightly and regularly packed adjacent to neighbouring containers, without compromising freight capacity. However, the reversible attachment portion may advantageously allow the attachment to be coupled to the intermodal container as desired, for example during road or rail freight, to reduce drag.

The at least one aerodynamic panel may comprise a pair of opposing side panels, and an upper panel, coupled to a first end of each of the pair of opposing side panels, wherein the first end of each of the pair of opposing side panels is configured to be situated furthest away from a road surface or rail in use. The pair of opposing side panels and the upper panel may be arranged to provide a tapered structure, wherein the upper panel and the pair of opposing side panels are each configured to be arranged at an acute angle relative to the first surface of the intermodal container. The tapered structure may be configured to have a cross section which reduces with increasing distance from the first surface of the intermodal container. For example, the upper panel and the pair of opposing side panels may be tapered relative to the cross section of the intermodal container. This may be advantageous to provide an enhanced reduction in drag.

The at least one aerodynamic panel may further comprise a lower panel, wherein the lower panel is coupled to a second end of the pair of opposing side panels, wherein the second end of each of the pair of opposing side panels is configured to be situated closest to the road surface or rail in use. For example, wherein the lower panel is arranged opposite to the upper panel. This may also be advantageous to provide an enhanced reduction in drag.

In some examples, the pair of opposing side panels, the upper panel, and the lower panel are arranged to provide a tapered structure, wherein the tapered structure forms a frustrum of a square-based pyramid. The tapered end of the frustrum may be configured to extend away from the first surface of the intermodal container.

The pair of side panels may be configured to be arranged at the same acute angle relative to the first surface of the intermodal container. Optionally, the pair of side panels and the upper panel may be configured to be arranged at the same acute angle relative to the first surface of the intermodal container. For example, the pair of side panels and the upper panel may be configured to be arranged at any angle greater than 0 and less than or equal to 90 degrees relative to the first surface of the intermodal container; optionally, any angle between 70 and 85 degrees relative to the first surface of the intermodal container; optionally between 75 and 85 degrees; optionally between 77 and 83 degrees; and/or optionally 80 degrees relative to the first surface of the intermodal container.

The lower panel may be configured to be arranged at a smaller acute angle relative to the first surface of the intermodal container compared to the upper panel. This may be advantageous to improve the reduction in drag. For example, the lower panel may be configured to be arranged at approximately between 40 to 50 degrees relative to the first surface of the intermodal container, however the skilled person will understand that this example is not limiting. In some examples, the lower panel may be configured to be arranged at approximately 45 degrees relative to the first surface of the intermodal container, however the skilled person will understand that this example is also not limiting.

The at least one aerodynamic panel may be a flat panel. Alternatively, the at least one aerodynamic panel may be curved, for example wherein the at least one aerodynamic panel may be an aerofoil. Optionally, at least one of the pair of opposing aerodynamic panels and the upper panel may be curved, wherein the remaining non-curved aerodynamic panels are flat.

The at least one aerodynamic panel may be configured to be transitioned between an aerodynamic configuration and a stored configuration, wherein the at least one aerodynamic panel is configured to be arranged at an acute angle relative to the first surface of the intermodal container in the aerodynamic configuration. This may be advantageous to store the aerodynamic panel(s) when not in use, for example when parked, without taking up space unnecessarily.

The at least one aerodynamic panel may be configured to be arranged substantially parallel relative to the first surface of the intermodal container in the stored configuration. This may be advantageous to reduce the profile of the aerodynamic panels relative to the intermodal container in the stored configuration.

In some examples, the intermodal container attachment may comprise at least one hinge, wherein each hinge is coupled to an aerodynamic panel such that each aerodynamic panel is configured to be transitioned between the aerodynamic configuration and the stored configuration via the respective hinge.

The attachment portion may further comprise an actuator means configured to transition the at least one aerodynamic panel between the aerodynamic configuration and the stored configuration, for example wherein the actuator means may comprise, but is not limited to, a hydraulic system, a motor, or other mechanical drive system. The actuator means may be actuated manually or automatically, for example using pneumatic, hydraulic, or electric actuators controlled by a central control system, or for example by a manual hand-cranked gearbox. Sensors may be incorporated to detect the presence or absence of an intermodal container and activate the actuator means accordingly to deploy the panels in the presence of the container, and/or to store the panels in the absence of a container.

In some examples, the at least one aerodynamic panel may comprise telescopic sections that allow the panel to extend or retract to accommodate containers of different sizes. An actuator means may also be provided to deploy the telescopic sections of the at least one aerodynamic panel accordingly.

The aerodynamic panels may also be adjustable based on environmental factors, such as wind speed and direction. Environmental sensors may be incorporated, for example to detect wind speed and direction, and a controller may be configured to adjust the aerodynamic panels accordingly based on signals from the environmental sensors. The at least one attachment portion may be configured to couple to a corner casting of the intermodal container, wherein the corner casting is preferably adjacent to the first surface of the intermodal container. This may be advantageous to enable the intermodal container attachment to couple to an intermodal container in a reliable and secure manner, without requiring modification to existing intermodal containers. The corner casting may be, but is not limited to an ISO 1161 corner casting.

The at least one attachment portion may comprise a hook portion configured to engage with a corner casting of the intermodal container. For example, the hook portion may be configured to engage with an aperture in a corner casting of the intermodal container, such as, but not limited to an ISO 1161 corner casting.

The at least one attachment portion may, additionally or instead, comprise a latch portion configured to engage with a corner casting of the intermodal container. For example, the latch portion may be configured to engage with an aperture in a corner casting of the intermodal container, such as, but not limited to an ISO 1161 corner casting.

The latch may comprise an engagement portion coupled to a drive bar. The drive bar may be configured to rotate to drive rotation of the engagement portion. The engagement portion may be configured for a first configuration wherein the engagement portion may be inserted into an aperture of a corner casting of an intermodal container, and a second configuration wherein the engagement portion is configured to be retained within the aperture of a corner casting. The engagement portion may be configured to be transitioned between the first configuration and the second configuration by rotation of the drive bar.

The engagement portion may have a width and a length, wherein the aspect ratio is greater than one. The width of the engagement portion may be configured to be less than the width of the aperture of the respective corner casting, and the length of the engagement portion may be configured to be less than the length of the respective aperture of the corner casting, however the length engagement portion may be configured to be greater than the width of the respective aperture of the corner casting. As such, in the first configuration, wherein the longitudinal axis of the engagement portion approximately aligns with the longitudinal axis of the respective aperture of the corner casting, the engagement portion may be configured to be inserted into the aperture. Conversely, in the second configuration, wherein the longitudinal axis of the engagement portion is misaligned with the longitudinal axis of the respective aperture of the corner casting, the engagement portion may be configured to be retained within the aperture of the corner casting of an intermodal container.

The at least one aerodynamic panel may comprise a composite polymer. This may be advantageous to provide sufficient rigidity to the panels to maintain their shape and provide the aerodynamic advantages, whilst reducing weight. Minimising the weight of the intermodal container attachment may be advantageous to optimise the improvements to vehicle fuel efficiency which may otherwise be comprised by the additional weight of the container attachment. Optionally, the composite polymer may be a fibre-reinforced polymer (FRP), such as, but not limited to, a glass reinforced plastic (GRP).

In some examples, the at least one aerodynamic panel may comprise a core material, and composite polymer shell at least partially surrounding the core material, wherein the core material has a lower density than the composite polymer. This may be further advantageous to provide sufficient rigidity to the panels to maintain their shape and provide the aerodynamic advantages, whilst minimising the weight of the container attachment by providing a lightweight, lower density core material. Optionally, the composite polymer may be a fibre-reinforced polymer (FRP), such as, but not limited to, a glass reinforced plastic (GRP). Optionally, the core material may be a porous material, such as a foam, for example a polymer foam.

Alternatively, in some examples, the at least one aerodynamic panel is reversibly inflatable, wherein the at least one aerodynamic panel is configured to be inflated in the aerodynamic configuration, and wherein the at least one aerodynamic panel is configured to be deflated in the stored configuration. This may be advantageous to provide a lightweight intermodal container attachment. In some examples, the intermodal container attachment may further comprise a pump configured to inflate the at least one inflatable aerodynamic panel. Alternatively, the at least one inflatable aerodynamic panel may be inflated in use by airflow over the intermodal container during transit.

In some examples, the intermodal container attachment may be configured to be coupled to a skeletal trailer for attachment to an intermodal container. For example, the intermodal container attachment may comprise at least one attachment means configured to be coupled to a skeletal trailer (also referred to as a trailer attachment means). Preferably, the attachment means may be coupled (directly or indirectly) to the at least one aerodynamic panel via a pivot. This may be advantageous to allow the intermodal container attachment to be pivoted relative to the skeletal trailer, even when coupled via the at least one trailer attachment means.

Another aspect of this invention provides a skeletal trailer for transporting an intermodal container. A skeletal trailer, also known as a chassis trailer, or container chassis, is a type of trailer configured for transporting containers. In particular, a skeletal trailer may be configured to be towed by a tractor unit for over-the-road transportation, sometimes known as drayage trucking. The skeletal trailer comprises a chassis and at least one aerodynamic panel coupled to the chassis. The at least one aerodynamic panel is configured to be arranged adjacent to a first surface of the intermodal container, wherein the intermodal container is configured to couple a tractor unit, and wherein the first surface of the intermodal container is configured to be a surface of the intermodal container situated furthest away from the tractor unit. Furthermore, the at least one aerodynamic panel is configured to be arranged at an acute angle relative to the first surface of the intermodal container when the attachment portion is coupled to the intermodal container. Providing a skeletal trailer with an aerodynamic panel may be advantageous to enable the at least one aerodynamic panel to be easily coupled to an intermodal container whilst the intermodal container is coupled to a skeletal trailer for transit. This also easily allows the same at least one aerodynamic panel to be reused for any intermodal container loaded onto the skeletal trailer for transit.

The at least one aerodynamic panel may be arranged at a distal end of the chassis, wherein the distal end is configured to be an end situated furthest away from a tractor unit, wherein the skeletal trailer is configured to couple to the tractor unit.

In some examples, the skeletal trailer the intermodal container attachment of the preceding aspect of the invention, as described above. The intermodal container attachment is coupled to the chassis of the skeletal trailer, wherein the at least one aerodynamic panel is the at least one aerodynamic panel of the intermodal container attachment of the preceding aspect of the invention. This may be advantageous to enable the intermodal container attachment to be easily coupled to an intermodal container whilst the intermodal container is coupled to a skeletal trailer for transit. This also easily allows the same intermodal container attachment to be reused for any intermodal container loaded onto the skeletal trailer for transit.

The intermodal container attachment may be arranged at a distal end of the chassis, wherein the distal end is configured to be an end situated furthest away from a tractor unit, wherein the skeletal trailer is configured to couple to the tractor unit.

The skeletal trailer may comprise an actuation means configured to transition the intermodal container attachment between a coupled configuration and an uncoupled configuration, wherein the intermodal container attachment is configured to be coupled to an intermodal container in the coupled configuration, and wherein the intermodal container attachment is configured to be uncoupled from an intermodal container in the uncoupled configuration. The actuation means may comprise, but is not limited to, at least one of a hydraulic system, a motor, or other mechanical drive system.

The actuation means may be configured to transition the intermodal container attachment between the coupled configuration and the uncoupled configuration by pivoting the intermodal container attachment relative to the chassis. For example, the intermodal container attachment may be configured to be pivoted towards the chassis and/or the intermodal container in the coupled configuration, and pivoted away from the chassis and/or the intermodal container in the uncoupled configuration.

### DRAWINGS

Embodiments of the disclosure will now be described, by way of example only, with reference to the accompanying drawings, in which:

FIG. 1 shows an isometric view of an example intermodal container attachment of the present invention.

FIG. 2 shows a front view of the example intermodal container attachment of FIG. 1.

FIG. 3 shows a side view of the example intermodal container attachment of FIGS. 1 and 2.

FIG. 4 shows a detailed cross-section view of a hook attachment portion of the example intermodal container attachment of FIGS. 1 to 3.

FIG. 5 shows a detailed cross-section view of a latch attachment portion of the example intermodal container attachment of FIGS. 1 to 3.

FIG. 6A shows an isometric view of the example intermodal container attachment of FIGS. 1 to 3 in use, coupled to an intermodal container on a truck.

FIG. 6B shows an isometric view of an example intermodal container, such as the intermodal container of FIG. 6A, for reference.

FIG. 7A shows an example fluid dynamics model of a typical truck, comprising a tractor and trailer, and an intermodal container.

FIG. 7B shows an example fluid dynamics model of the typical truck and intermodal container of FIG. 7A, additionally comprising the intermodal container attachment of FIGS. 1 to 3. FIG. 7B illustrates that the intermodal container attachment results in a reduction in drag compared to the truck and container of FIG. 7A.

FIG. 8A shows an isometric view of an example skeletal trailer comprising an intermodal container attachment, such as the intermodal container attachment of FIGS. 1 to 3, wherein the intermodal container attachment illustrated in the stored configuration.

FIG. 8B shows an isometric view of the example skeletal trailer of FIG. 8A, comprising the intermodal container attachment, such as the intermodal container attachment of FIGS. 1 to 3, wherein the intermodal container attachment illustrated in the loading configuration.

FIG. 9 shows an isometric view of the example skeletal trailer of FIG. 8A, comprising the intermodal container attachment, such as the intermodal container attachment of FIGS. 1 to 3, wherein the intermodal container attachment illustrated in use in the coupled configuration, coupled to an intermodal container.

FIG. 10A shows an isometric view of an alternative example intermodal container attachment, coupled to an intermodal container, wherein the intermodal container attachment is configured to couple to a skeletal trailer.

FIG. 10B shows a schematic view of the frame of the example intermodal container attachment of FIG. 10A.

FIG. 11A shows an isometric view of an example skeletal trailer comprising an intermodal container attachment, wherein the intermodal container attachment illustrated in the loading configuration.

FIG. 11B shows an isometric view of the skeletal trailer of FIG. 11B, wherein the intermodal container attachment illustrated as being transitioned into the stored configuration.

FIG. 11C shows an isometric view of the skeletal trailer of FIGS. 11A and 11B, wherein the intermodal container attachment illustrated as being in the stored configuration.

FIG. 12A shows an example skeletal trailer comprising an intermodal container attachment, such as that of FIGS. 11A to 11C, wherein the intermodal container attachment illustrated in the loading configuration, and wherein an intermodal container is shown as being loaded onto the skeletal trailer.

FIG. 12B shows a detail view of the attachment means of intermodal container attachment of FIG. 12A for attaching to the intermodal container in the aerodynamic (or “deployed”) configuration.

FIG. 13 shows a side view of an example skeletal trailer comprising an intermodal container attachment, such as that of FIGS. 12A, wherein the intermodal container attachment illustrated in the aerodynamic (or “deployed”) configuration, coupled to an intermodal container loaded onto the skeletal trailer.

FIG. 14 shows an isometric view of an intermodal container attachment, such as the attachment of FIGS. 11A to 13, configured to be coupled to a skeletal trailer.

### SPECIFIC DESCRIPTION

Embodiments of the claims relate to an intermodal container attachment, in particular an intermodal container attachment for reducing drag of an intermodal container when coupled to a tractor unit.

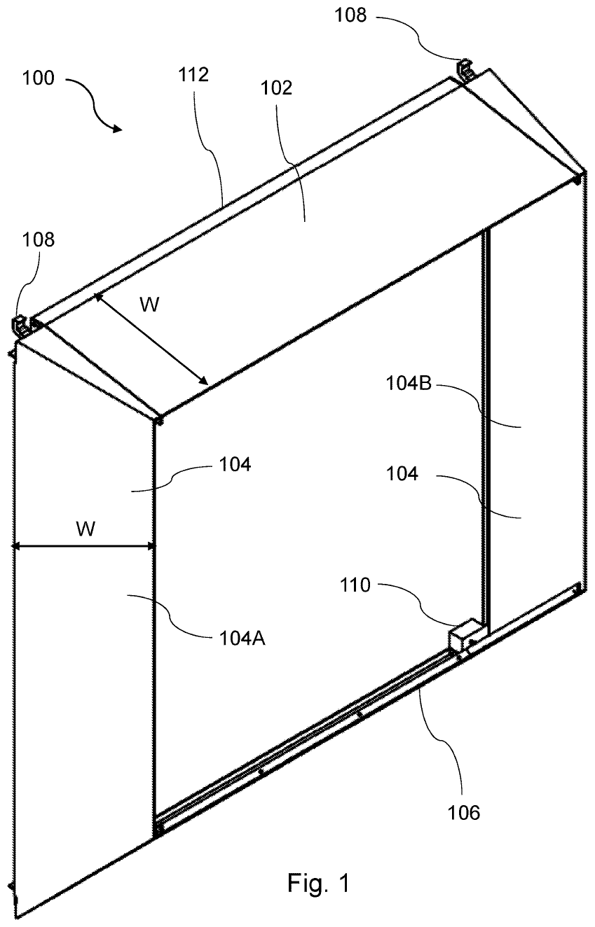

FIG. 1 shows an isometric view of an example intermodal container attachment 100 of the present invention. The intermodal container attachment 100 comprises a pair of opposing aerodynamic side panels 104A and 104B, an aerodynamic upper panel 102, and an aerodynamic lower panel 106. In the example shown, each aerodynamic panel 104A, 104B, 102, and 106 is a flat panel. The upper panel 102 and lower panel 106 are both arranged between the pair of opposing side panels 104A and 104B. The upper panel 102 is coupled at a first end of each of the pair of opposing side panels 104A and 104B, wherein the first end of each of the pair of opposing side panels 104A and 104B is configured to be situated furthest away from a road surface in use. The lower panel 106 is coupled to a second end of the pair of opposing side panels 104A and 104B, wherein the second end of each of the pair of opposing side panels 104A and 104B is opposite to the first end, such that the second end is configured to be situated closest to the road surface in use.

The upper panel 102 is also coupled to an upper horizontal bar 112 which is arranged along a first edge of the upper panel 102. The upper horizontal bar 112 is substantially the same length as the upper panel 102. The first edge is the edge of the upper panel 102 which is configured to be closest to the first surface of the container in use. The upper horizontal bar 112 is configured to abut the rear header of the intermodal container in use, wherein the rear header is the portion of the container between the upper rear corner castings. The upper horizontal bar 112 may be advantageous to provide stability and rigidity to the intermodal container attachment 100, in particular to the upper panel 102. Furthermore, the upper horizontal bar 112 may enhance contact between the intermodal container and the upper panel 102 to provide a seal, thus improving the aerodynamic performance of the upper panel 102.

Optionally, the lower panel 106 is also coupled to a lower horizontal bar (not shown) which is arranged along a first edge of the lower panel 106 and is substantially the same length as the lower panel 106. The first edge is configured to be the edge of the lower panel 106 closest to the first surface of the container in use. The lower horizontal bar is configured to abut the rear sill of the intermodal container in use, wherein the rear sill is the portion of the container between the lower rear corner castings. The lower horizontal bar may be advantageous to provide stability and rigidity to the intermodal container attachment 100, in particular to the lower panel 106. Furthermore, the lower horizontal bar may enhance contact between the intermodal container and the lower panel 106 to provide a seal, thus improving the aerodynamic performance of the lower panel 106.

The second end of each of the pair of opposing side panels 104A and 104B may comprise a track on the inner surface (not shown). The tracks may be configured to receive opposite short edges of the lower panel 106, for example wherein the tracks are configured to couple the lower panel 106 to the pair of side panels 104A and 104B.

The pair of side panels 104A and 104B, upper panel 102, and lower panel 106 are each angled inwards relative to one another, such that they are arranged to provide a tapered open box structure. As shown, the angled panels 104A, 104B, 102, and 106 are arranged into a frustrum of a square-based pyramid shape. This may be advantageous to provide an enhanced reduction in drag.

The pair of side panels 104A and 104B, upper panel 102, and lower panel 106 are each configured to be arranged at an acute angle relative to the first surface of the intermodal container when the attachment portion is coupled to the intermodal container, wherein the first surface of the intermodal container is configured to be the surface of the intermodal container situated furthest away from the coupled tractor unit in use, i.e., the rear surface of the intermodal container. The cross section formed between the pair of side panels 104A and 104B, the upper panel 102, and the lower panel 106 is configured to reduce proportionally to the distance from the first surface of the intermodal container in use.

The lower panel 106 is configured to be arranged at a smaller acute angle relative to the first surface of the intermodal container compared to the upper panel 102. In this example, the lower panel 106 is configured to be arranged at approximately 45 degrees relative to the first surface of the intermodal container.

The pair of side panels 104A and 104B are configured to be arranged at the same acute angle relative to the first surface of the intermodal container. In this example, the pair of side panels 104A and 104B and the upper panel 102 are configured to be arranged at the same acute angle relative to the first surface of the intermodal container.

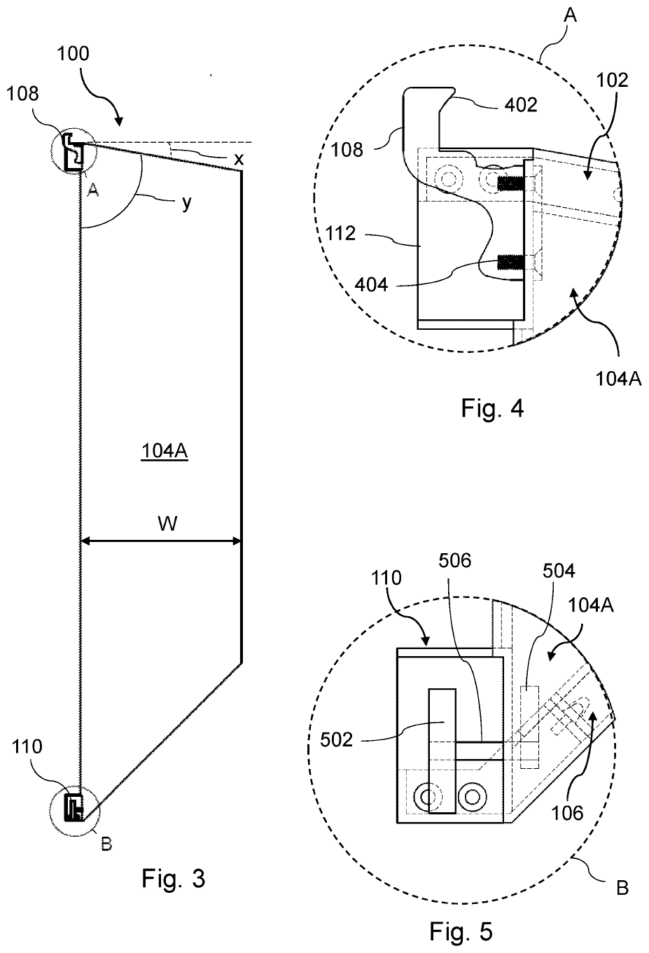

Purely for illustrative purposes, the below table includes some experimental data illustrating the relationship between panel width and tapering angle. Panel width has been indicated as W on FIGS. 1 and 3. Panel width is configured to determine how far the respective panel is configured to extend from the rear surface of the intermodal container, i.e, wherein a greater panel width equates to a longer intermodal container attachment.

In this example, the tapering angle is defined with respect to the orthogonal plane of the rear surface of the intermodal container. Tapering angle for the upper panel 102 (not shown) has been indicated as x on FIG. 3. For example, a tapering angle, x, of 10 degrees is equivalent to 80 degrees relative to the rear surface of the intermodal container, indicated as y on FIG. 3. Likewise, a tapering angle, x, of 13 degrees is equivalent to 77 degrees relative to the rear surface of the intermodal container, y, and so on. For the data below, the same tapering angle was applied to each of the pair of side panels 104A and 104B and the upper panel 102. The lower panel 106 was kept constant at a tapering angle of approximately 45 degrees.

Drag reduction is provided as a percentage reduction relative to a control model without an intermodal container attachment.

| | Tapering angle | Drag reduction | Additional |
|---|---|---|---|
| Panel width (mm) | (deg) | (%) | information |
| 1210 | 13 | 5 | |
| 1210 | 10 | 9 | |
| 600 | 13 | 15 | |
| 600 | 10 | 16 | |
| 1210 | 13 | 8 | Curved panel |
| 300 | 15 | 12 | |
| 300 | 10 | 13 | |
| 600 | 10 | 18 | Curved panel |
| 600 | 10 | 19 | Curved panel + |
| | | | deflector |

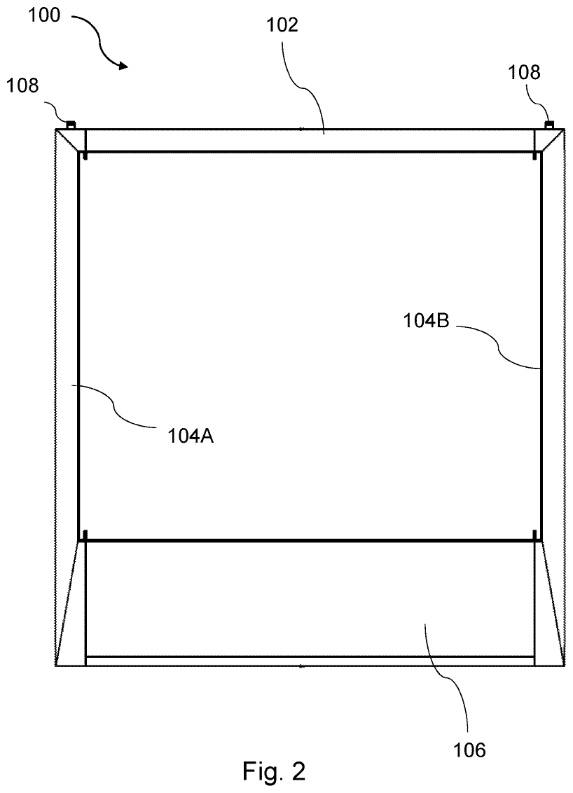

For the example shown in FIGS. 1 to 3 which comprises flat panels, the preferred tapering angle for the pair of side panels 104A and 104B, and the upper panel 102, may be 10 degrees. However, the skilled person will understand this is only one example, and should not be construed to be limiting. For example, the tapering angle may be any angle between 0 and less than 90 degrees in the aerodynamic configuration (i.e., wherein the angle between the panel and the rear surface of the intermodal container in the aerodynamic configuration may be any angle greater than 0 and less than or equal to 90 degrees). Optionally, the tapering angle may be any angle between 5 and 20 degrees in the aerodynamic configuration; optionally between 5 and 15 degrees; and/or optionally between 7 and 13 degrees.

Returning to the example shown in FIGS. 1 to 3, the intermodal container attachment 100 further comprises a plurality of attachment portions. In the example shown, the plurality of attachment portions comprise a pair of hook attachment portions 108. A hook attachment portion 108 is coupled to the upper end of each side panel 104A and 104B, for example via screws 404, wherein the upper end is defined as the end situated furthest away from a road surface in use. Each hook attachment portion 108 is arranged on a first surface of the intermodal container attachment 100, wherein the first surface of the intermodal container attachment 100 is configured to be adjacent to the rear surface of the intermodal container in use. An example hook attachment portion 108 is shown in more detail in FIG. 4. The hook 108 extends from the first surface of the side panel 104 and protrudes above the upper panel 102 of the container attachment 100. The hook 108 comprises an engagement lip 402 at the distal end of the hook 108 which bends towards the upper panel 102 and/or the first surface of the side panel 104.

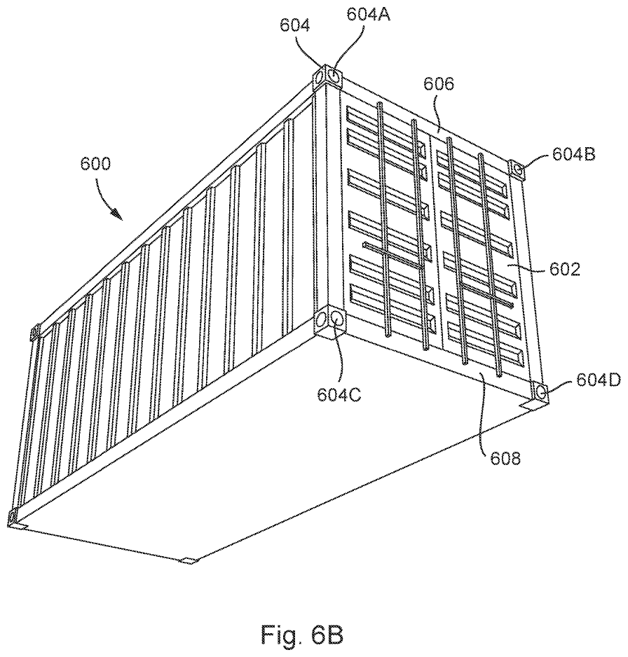

Each hook attachment portion 108 is configured to reversibly engage with an upper, rear corner casting of the intermodal container, wherein each corner casting comprises an aperture configured to receive the hook. Thus, each hook attachment portion 108 is configured to reversibly engage with an aperture of a corner casting of the intermodal container, such as, but not limited to, an ISO1161 corner casting. The upper, rear corner castings are configured to be the uppermost corner castings of an intermodal container relative to the road surface, arranged on the rear surface of the intermodal container, wherein the rear surface is configured to be the surface of the container situated furthest away from the tractor. An example intermodal container is shown in FIG. 6B.

The engagement lip 402 is configured to retain the hook portion 108 within an aperture of the corner casting of an intermodal container when the container attachment 100 is adjacent to the rear surface of the intermodal container.

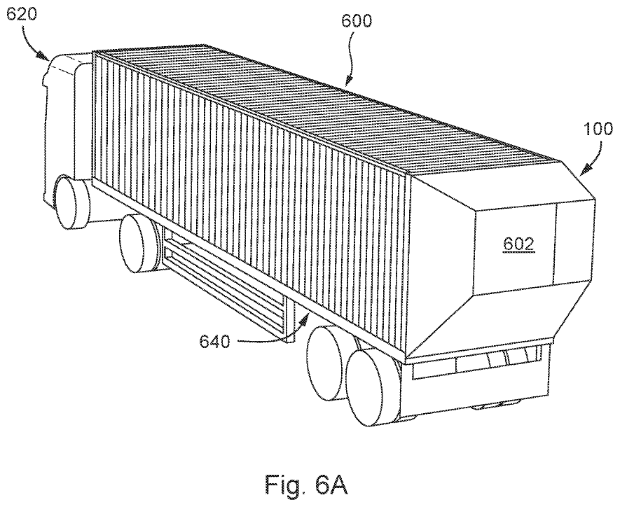

The plurality of attachment portions further comprise a pair of latch attachment portions 110. A latch attachment portion 110 is coupled to the lower end of each of the pair of side panels 104A and 104B, wherein the lower end is defined as the end situated closest to the road surface in use. An example latch attachment portion 110 is shown in more detail in FIG. 5.

Each latch 110 has an engagement portion 502 and a handle portion 504 coupled by a drive bar 506. The handle portion 504 is configured to rotate such that rotation of the handle portion 504 drives rotation of the engagement portion 502, via the drive bar 506. The engagement portion 502 is situated on a first side of the container attachment 100, wherein the first side is configured to be adjacent to the rear surface of the intermodal container in use. The handle portion 504 is arranged on the opposite side of the container attachment 100 to the engagement portion 502, wherein the handle portion 504 extends in the same direction to the aerodynamic side panel 104.

Each latch attachment portion 110 is configured to reversibly engage with a lower, rear corner casting of the intermodal container, wherein each corner casting comprises an aperture having an aspect ratio greater than one, configured to receive the engagement portion 502 of the latch 110. Thus, each engagement portion 502 of the latch 110 is configured to reversibly engage with an aperture of a corner casting of the intermodal container, such as, but not limited to, an ISO1161 corner casting. The lower, rear corner castings are configured to be the lowermost corner castings of an intermodal container relative to the road surface, arranged on the rear surface of the intermodal container, wherein the rear surface is configured to be the surface of the container situated furthest away from the tractor.

The engagement portion 502 has a width and a length, wherein the aspect ratio is greater than one. The width of the engagement portion 502 is configured to be less than the width of the respective aperture of the corner casting, and the length of the engagement portion 502 is configured to be less than the length of the respective aperture of the corner casting, however the length engagement portion 502 is configured to be greater than the width of the respective aperture of the corner casting. As such, in a first configuration, wherein the longitudinal axis of the engagement portion 502 approximately aligns with the longitudinal axis of the respective aperture of the corner casting, the engagement portion 502 is configured to be inserted into the aperture. Conversely, in a second configuration, wherein the longitudinal axis of the engagement portion 502 is rotated to misalign with the longitudinal axis of the corner casting aperture, for example wherein the longitudinal axes of the engagement portion 502 and the corner casting aperture are orthogonal, the engagement portion 502 is configured to be retained within an aperture of the corner casting of an intermodal container. The engagement portion 502 may be transitioned between the first configuration and the second configuration by actuation of the handle portion 504.

As such, each hook portion 108 and latch portion 110 are configured to reversibly couple to an intermodal container, such that the aerodynamic panels 104A, 104B, 102, and 106 are configured to be arranged adjacent to the first surface of the intermodal container.

In this example, the aerodynamic panels 104A, 104B, 102, and 106 comprise a porous polymer core material, and glass reinforced plastic (GRP) shell surrounding the core, wherein the core material has a lower density than the GRP. However, the skilled person will understand this is merely one example, and any other suitable material may be used. In some alternative embodiments, the aerodynamic panels 104A, 104B, 102, and 106 are configured to be reversibly inflatable.

FIG. 6A shows an example of the intermodal container attachment 100 coupled to an intermodal container 600. The intermodal container 600 is coupled to a tractor 620 via a trailer 640, known as a skeletal trailer. The intermodal container 600 is arranged on an upper loading surface of the trailer 640 chassis, wherein the upper loading surface is defined as the surface of the trailer 640 facing away from the road surface and configured to receive the intermodal container 600. The front end of the trailer 640 is coupled to a tractor unit 620, wherein the tractor unit is configured to tow the trailer 640 and intermodal container 600.

The intermodal container attachment 100 is arranged adjacent to the rear surface 602 of the container 600, wherein the rear surface 602 is configured to be the surface of the container 600 situated furthest away from the tractor unit 620. An example of an intermodal container 600 is shown in more detail in FIG. 6B. The intermodal container 600 may be, but is not limited to, an ISO 668 intermodal container. The rear surface 602 of the intermodal container 600 comprises four corner castings 604: a left-hand upper rear corner casting 604A, a right-hand upper rear corner casting 604B, a left-hand lower rear corner casting 604C, and a right-hand lower rear corner casting 604D. Each corner casting 604 comprises at least one aperture. The corner castings 604 may be, but are not limited to ISO 1161 castings. The intermodal container 600 further comprises a horizontal bar known as a rear header 606, arranged between the left-hand upper rear corner casting 604A and the right-hand upper rear corner casting 604B; and a horizontal bar known as a rear sill 608, arranged between the left-hand lower rear corner casting 604C and the right-hand lower rear corner casting 604D.

Each of the aerodynamic panels 102, 104A, 104B, and 106 may be configured to be transitioned between an aerodynamic configuration (shown) and a stored configuration (not shown). The aerodynamic panels are configured to be arranged at an acute angle relative to the first surface of the intermodal container in the aerodynamic configuration, as shown. However, the aerodynamic panels may be configured to be arranged substantially parallel relative to a surface of the intermodal container 600 in the stored configuration (not shown). For example, each aerodynamic panel may be configured to be hinged relative to the intermodal container 600, such that each aerodynamic panel is configured to be transitioned between the aerodynamic configuration and the stored configuration via rotation of the respective hinge.

In use, to assemble and attach the intermodal container attachment 100 to the container 600 in the aerodynamic configuration, the upper panel 102 is coupled between the pair of opposing side panels 104A and 104B which comprise the pair of hooks 108 and the pair of latches 110. The upper panel 102 and side panels 104A and 104B are raised to the rear surface intermodal container attachment 100 and the hooks 108 are engaged with the apertures of the upper rear corner castings 604A and 604B of the container 600. To engage the hooks 108 within the apertures, the lower end of the side panels 104A and 104B may be tilted away from the rear surface 602 of the intermodal container 600 to insert the hook portions 108 into the apertures of the upper rear corner castings, 604A and 604B. As the lower end of each side panels 104A and 104B is then pivoted towards the rear surface 602 of intermodal container 600, the engagement lip 402 of the hook 108 engages with an inner surface of the corner casting to retain the hook within the corner casting. In this configuration, the upper horizontal bar 112 is arranged adjacent and parallel to the rear header 606.

The engagement portion 502 of each latch 110 is transitioned into the first configuration such that the longitudinal axes of the latch engagement portion 502 and the aperture of the lower rear corner casting substantially align. As the lower end of the side panels 104A and 104B are brought towards the rear surface 602 of intermodal container 600, each engagement portion 502 is therefore inserted into the aperture of the respective lower rear corner casting. Once the side panels 104A and 104B are adjacent and parallel to the rear surface 602 of the container 600, a user may then transition each latch 110 into the second configuration to reversibly secure the intermodal container attachment 100 to the intermodal container 600 by turning the respective handle portion 504 of each latch 110.

The lower panel 106 may then optionally be coupled to the intermodal container attachment 100. In this example, the lower end of the inward-facing surface of each opposing side panel 104A and 104B comprises a track, wherein the track is configured to receive the opposing edges of the lower panel 106. As such, opposite edges of the lower panel 106 are therefore inserted into the tracks to couple the lower panel 106 between the pair of side panels 104A and 104B.

However, in other examples, the skilled person will understand that the intermodal container attachment 100 may be coupled to the rear surface 602 of the container 600 in one piece, for example wherein the lower panel 106 is coupled to the side panels 104A and 104B prior to attaching the intermodal container attachment 100 to the container 600.

Alternatively, the skilled person will understand that the intermodal container attachment 100 may be coupled to the rear surface 602 of the container 600 as two separate halves. For example, the upper panel 102 may be split widthways into two adjacent panels (not shown), a first upper panel portion and a second upper panel portion. In such examples, the first upper panel portion is configured to be coupled to one of the pair of opposing side panels, and the second upper panel portion is configured to be coupled to the other of the pair of opposing side panels. The first upper panel portion and second upper panel portion are configured to couple to one another to form the upper panel 102. In use, the first upper panel portion is coupled to a first one of the pair of opposing side panels 104A, and the second upper panel portion is coupled to the second of the pair of opposing side panels 104B. The first upper panel portion and first side panel 104A are then coupled to the rear surface intermodal container attachment 100 by engaging the first hook 108 with the aperture of the left-hand upper rear corner casting of the container 600. As above, to engage the hook 108 within the aperture, the lower end of the first side panels 104A may be pivoted away from the rear surface 602 of the intermodal container 600 to insert the hook portion 108 into the aperture of the upper rear corner casting. As the lower end of the side panel 104A is then brought towards the rear surface 602 of intermodal container 600, the engagement lip 402 of the hook 108 engages with an inner surface of the corner casting to retain the hook within the corner casting. The second upper panel portion and second side panel 104B are then coupled to the rear surface intermodal container attachment 100 by engaging the second hook 108 with the aperture of the right-hand upper rear corner casting of the container 600 in the same manner. The first upper panel portion and the second upper panel portion may then be coupled together in situ to form the upper panel 102. As above, each latch 110 may also be transitioned into the second configuration in situ in order to reversibly secure the latch engagement portion 502 within the lower rear corner castings. The lower panel 106 may then optionally be coupled to the intermodal container attachment 100, for example by inserting the opposite edges of the lower panel 106 into a pair of tracks between the pair of side panels 104A and 104B, as above.

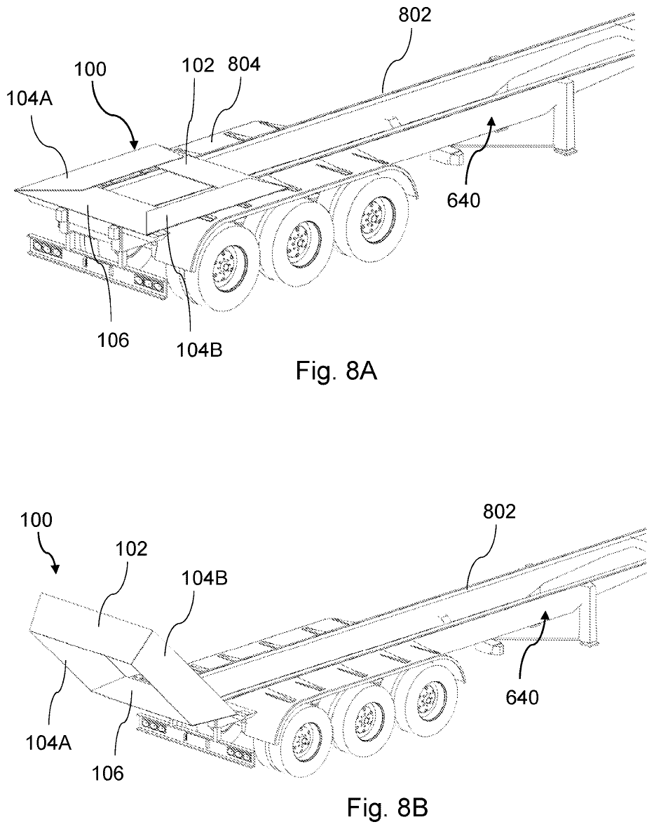

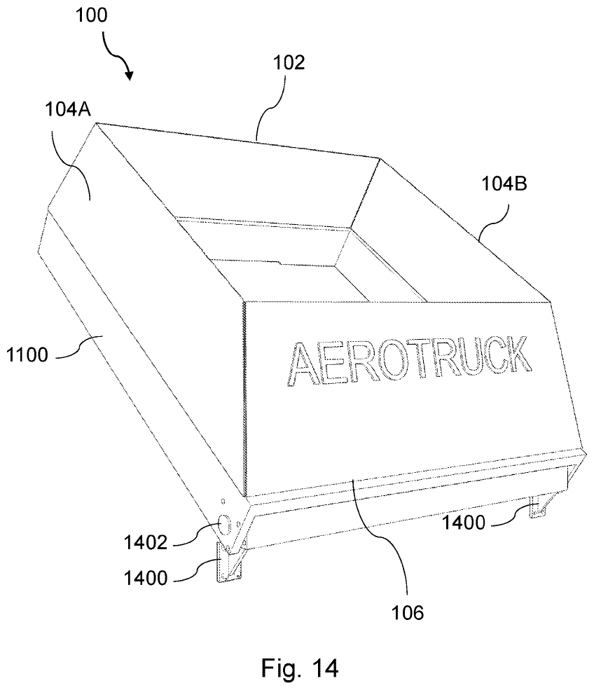

In some examples, the intermodal container attachment 100 may be directly coupled to the trailer 640. For example, FIGS. 8A to 9 and 11A to 13 show views of an example skeletal trailer 640 comprising an intermodal container attachment 100, such as the intermodal container attachment of FIGS. 1 to 3. As shown, the intermodal container attachment 100 is coupled to the rear end of the trailer chassis 802, wherein the rear end is the end of the chassis 802 which is configured to be situated furthest away from the tractor unit 620 in use. An example intermodal container attachment 100 is also shown in FIG. 14, comprising a pair of attachment means 1400 configured to be coupled to a skeletal trailer, for example by bolting or welding to a skeletal trailer chassis. The pair of attachment means 1400 configured to be coupled to a skeletal trailer are coupled to the lower corners of the frame 1100 of the intermodal container attachment 100 via pivots 1402. The pivots 1402 are configured to allow the frame 1100 of the intermodal container attachment 100 to pivot relative to the skeletal trailer, in particular relative to the upper loading surface of a skeletal trailer chassis.

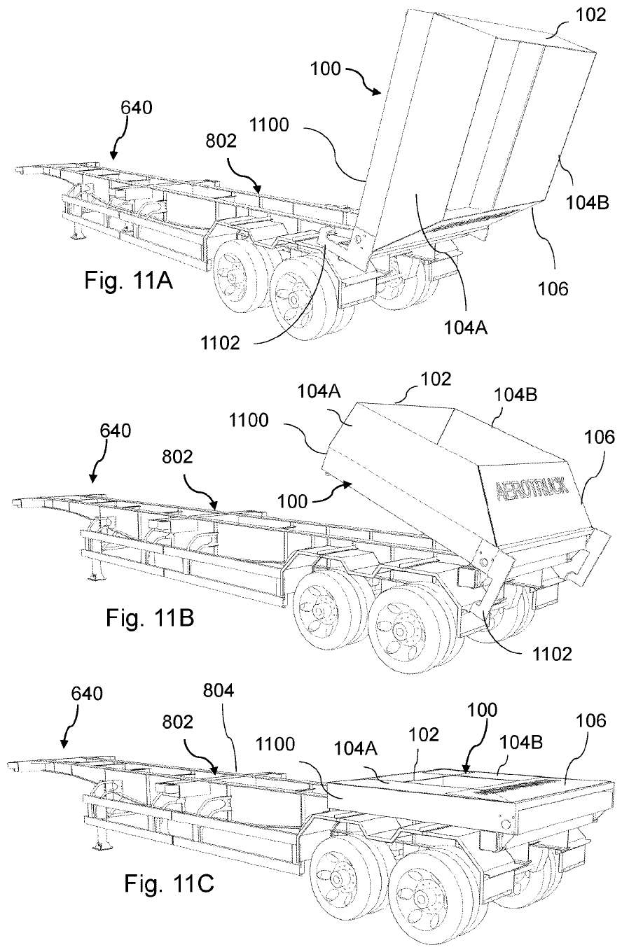

FIGS. 8A and 11C depict the intermodal container attachment 100 in the stored, uncoupled configuration, wherein each of the aerodynamic panels 102, 104A, 104B, and 106 are arranged substantially parallel and adjacent to the upper loading surface 804 of the chassis 802. The upper loading surface 804 is defined as the surface of the trailer chassis 802 configured to be furthest from the road surface in use, and configured to receive the intermodal container 600.

Each aerodynamic panel 102, 104A, 104B, and 106 is configured to pivot relative to a frame (not shown in FIG. 8A, see frame 1100 in FIG. 11A to 11C), wherein each panel 102, 104A, 104B, and 106 is coupled to the frame, for example via hinges. The frame is arranged on a first surface of the intermodal container attachment 100, wherein the first surface of the intermodal container attachment 100 is configured to be adjacent to the rear surface of the intermodal container 600 in use. In this example, the frame is configured to be substantially square. For example, the frame may comprise an upper horizontal bar 112, a lower horizontal bar, and two opposing side bars coupled together to form a square frame.

As such, each aerodynamic panel 102, 104A, 104B, and 106 is configured to be transitioned between the aerodynamic configuration (or deployed configuration), shown in FIGS. 8B and 9, 11A and 11B, and the stored configuration, shown in FIGS. 8A and 11C, via respective hinges. The aerodynamic panels 102, 104A, 104B, and 106 are configured to provide the tapered structure described in relation to FIG. 1 in the aerodynamic configuration. The stored configuration may be advantageous for transportation of the skeletal container when not coupled to a container, for example prior to collection, or after delivery, of a container.

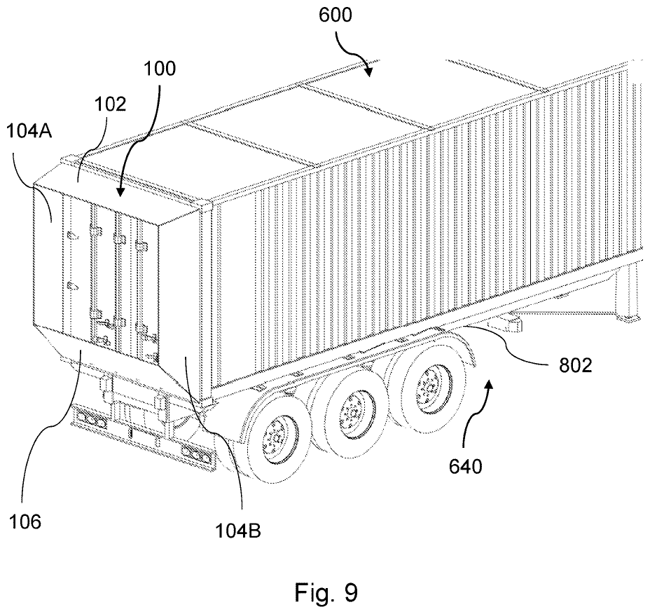

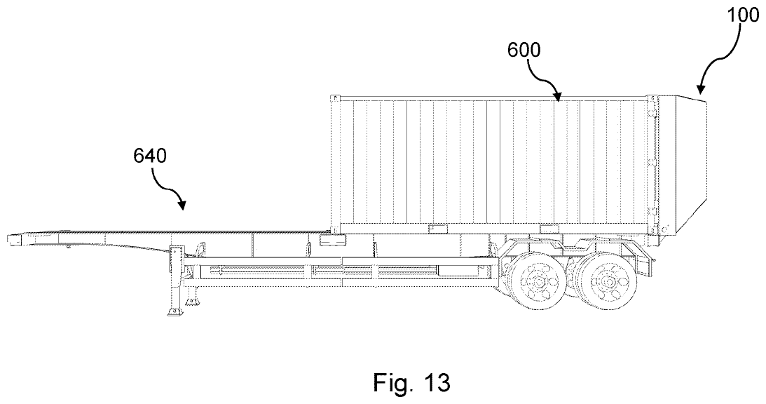

Furthermore, the intermodal container attachment 100 is also coupled to the rear end of the chassis 802 via a pivot, for example wherein the frame is coupled to the rear end of the chassis 802 via the pivot. As such, the intermodal container attachment 100 is configured to be transitioned between (i) the stored configuration of FIG. 8A and FIG. 11C; (ii) the loading configuration of FIG. 8B and FIG. 11A; and (iii) the coupled configuration of FIG. 9 and FIG. 13. In the stored configuration of FIG. 8A and FIG. 11C, the frame 1100 of the intermodal container attachment 100 is configured to be adjacent and parallel to the upper loading surface 804 of the chassis 802. In the loading configuration of FIG. 8B and FIG. 11A, the intermodal container attachment 100 is configured to be rotated over 90 degrees away from the upper loading surface 804 of the chassis 802. This may be advantageous for ease of loading an intermodal container onto the upper loading surface 804 of the trailer 640 without damaging the intermodal container attachment 100. In the coupled configuration of FIG. 9 and FIG. 13, the intermodal container attachment 100 is configured to be rotated approximately 90 degrees from the upper loading surface 804 of the chassis 802. In use in the coupled configuration, the intermodal container attachment 100 is configured to be parallel and adjacent to the rear surface 602 of an intermodal container 600.

The intermodal container attachment 100 may be configured to be transitioned between the stored configuration, the loading configuration, and the coupled configuration manually, or automatically via an actuator system, such as a hydraulic, pneumatic, or mechanical drive system.

As shown in FIGS. 11A and 11B, an actuator mechanism 1102 may be positioned near or about the lower pivot point of the intermodal container attachment 100 relative to the skeletal trailer chassis 802. This actuator mechanism 1102 is configured to be activated by the lowering of an intermodal container onto the trailer 802, thereby automatically transitioning the intermodal container attachment 100 from the loading configuration to the deployed configuration, seamlessly in conjunction with the lowering process of a container. As the container is lowered onto the trailer bed, the mechanism 1102 near the lower pivot point is triggered, initiating a controlled tilting motion of the frame 1100. This tilting action allows the frame 1100 to precisely align with the intermodal container.

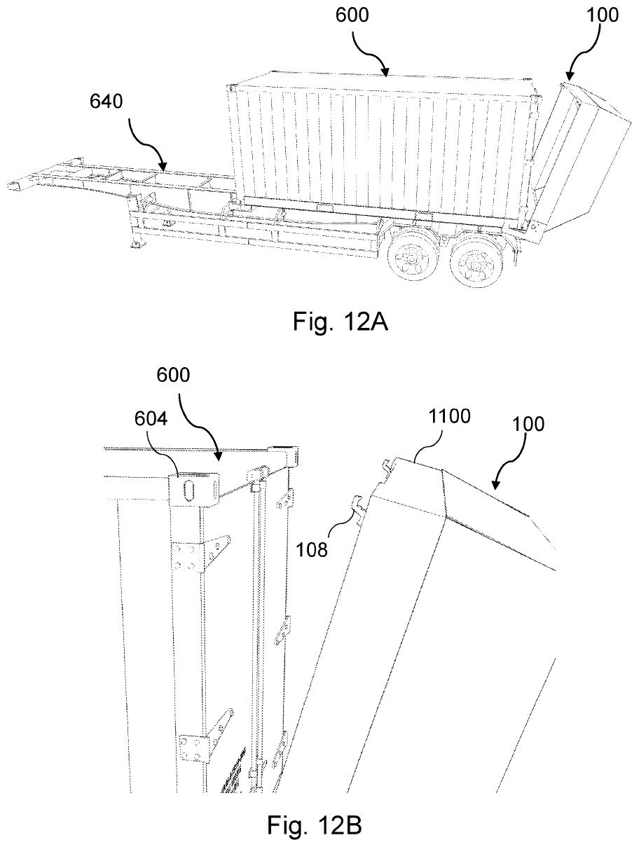

In use, the skeletal trailer 640 is coupled to a tractor unit 620. To load an intermodal container, such as intermodal container 600, on to the trailer 640, the intermodal container attachment 100 is pivoted from the stored configuration into the loading configuration. The aerodynamic panels 102, 104A, 104B, and 106 are also transitioned from the stored configuration into the aerodynamic configuration. An intermodal container, such as intermodal container 600, can then be loaded onto the upper loading surface 804 of the trailer chassis 802. Once the container 600 is loaded onto the trailer 640, the intermodal container attachment 100 is then pivoted into the coupling configuration. The intermodal container attachment 100 may then be coupled to the container 600 via at least one attachment means. For example, the at least one attachment means may comprise a pair of latch attachments 110 as described in relation to FIG. 5, for example wherein the latch attachments 110 are coupled to the upper end of each side panel 104A and 104B, and are configured to couple to the upper rear corner castings of the intermodal container 600. Alternatively, as shown in FIG. 12B, the at least one attachment means may comprise a pair of pair of hook attachments 108, for example wherein the hook attachments 108 are coupled to the upper corners of the frame 1100 and are configured to couple to the upper rear corner castings 604 of the intermodal container 600. However, the skilled person will understand that any other suitable attachment means may be used, preferably wherein the attachment means are configured to engage with the corner casting of an intermodal container. For example, in other examples, the attachment means may be configured to be passive, for example utilising a conformable material, such as rubber or elastomer, to deform and be retained within the corner castings or other fittings of an intermodal container. In other examples, the attachment means may comprise spring-loaded mechanism. This passive engagement ensures a secure connection without the need for manual intervention, simplifying the operation and enhancing user convenience. Alternatively, in another embodiment, the attachment means may comprise a manual locking mechanism that allows the user to manually secure the mechanism into place when the container is in position. This manual locking mechanism may provide an additional layer of security and allow the user to adjust the tension or tightness of the connection as needed. Moreover, in yet other examples, the attachment means may comprise an automatic locking feature, configured to engage when the container is positioned on the trailer.

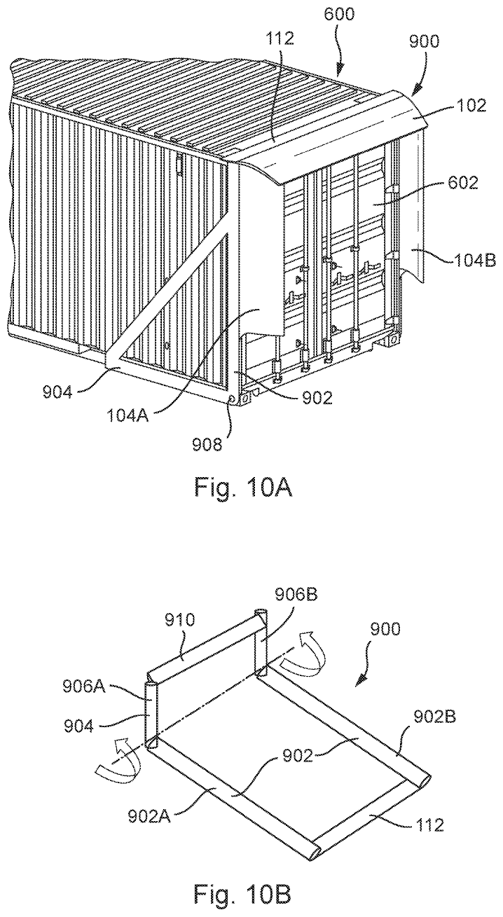

An alternative intermodal container attachment 900 configured for attachment to a skeletal trailer is shown in FIG. 10A, however the skeletal trailer has been omitted for ease of interpretation. Despite this, the intermodal container attachment 900 is coupled to the rear end of a trailer chassis, via a pivot 908, wherein the rear end is the end of the chassis which is configured to be situated furthest away from the tractor unit in use.

In this example, the intermodal container attachment 900 comprises a rear frame comprising an upper horizontal bar 112, and a pair of opposing side bars 902A and 902B, wherein the upper horizontal bar 112 is coupled between the upper ends of the pair of opposing side bars 902A and 902B. The upper horizontal bar 112 is coupled to an aerodynamic upper panel 102, and the pair of opposing side bars 902A and 902B are each coupled to a respective aerodynamic side panel, 104A and 104B. As described in relation to the embodiment of FIGS. 8A and 8B, the aerodynamic panels 102, 104A, and 104B may be hinged relative to the rear frame of the upper horizontal bar 112 and the pair of opposing side bars 902A and 902B such that the panels may be transitioned between an aerodynamic configuration having a tapered shape as shown in FIG. 10A, and a stored configuration (not shown) wherein the aerodynamic panels 102, 104A and 104B, may be stored parallel to the rear frame comprising the upper horizontal bar 112 and the pair of opposing side bars 902A and 902B.

Furthermore, the intermodal container attachment 900 comprises a base frame 904, wherein the base frame 904 is configured to be coupled perpendicular to the plane of the rear frame of the upper horizontal bar 112 and the pair of opposing side bars 902A and 902B. The base frame 904 is configured to be situated adjacent to the base of the intermodal container 600 in the coupled configuration in use, wherein the base is defined as the surface of the intermodal container situated closest to the road surface in use.

A schematic of the intermodal container attachment 900 comprising the base frame 904 and the rear frame comprising the upper horizontal bar 112 and the pair of opposing side bars 902A and 902B is shown in FIG. 10B in the loading configuration. The aerodynamic panels 102, 104A and 104B have been omitted for ease of interpretation. The base portion 904 comprises a pair of lower side bars 906A and 906B which are respectively coupled to the lower end of the pair of side bars 902A and 902B. A horizontal base bar 910 is coupled between the distal end of the pair of lower side bars 906A and 906B, wherein the distal end is the end of each lower side bar, 906A and 906B, opposite to the side bars 902A and 902B.

The intermodal container attachment 900 is coupled to the rear end of the chassis (not shown) via a pivot 908, wherein the pivot 908 is arranged at the intersection of the pair of side bars 902A and 902B of the rear frame, and the pair of lower side bars 906A and 906B of the base frame 904. As such, intermodal container attachment 900 is configured to be transitioned between at least (i) a loading configuration; and (ii) the coupled configuration of FIG. 10A. In the loading configuration, the rear frame is configured to be pivoted more than 90 degrees and less than 180 degrees from the upper loading surface of the trailer chassis. This in turn causes the base frame to be rotated up to 90 degrees from the upper loading surface of the trailer chassis. This may be advantageous for ease of loading an intermodal container onto the upper loading surface of the trailer without damaging the intermodal container attachment 900. As the intermodal container, such as container 600, is lowered onto the upper loading surface of the trailer, the base surface of the intermodal container 600 is configured to engage with the base frame 904 of the intermodal container attachment 900, in particular the base surface of the intermodal container 600 is configured to engage with the horizontal base bar 910. As such, as the container 600 is continually lowered onto the upper loading surface of the trailer, the intermodal container attachment 900 is pivoted towards the upper loading surface, until the base frame 904 is parallel and adjacent to the upper loading surface of the trailer chassis. This is referred to as the coupled configuration. The base frame 904 of the intermodal container attachment 900 may therefore be advantageous to transition the attachment 900 from the loading configuration into the coupled configuration during loading under the weight of the container 600. Optionally, the intermodal container attachment 900 may then be coupled to the container 600 via at least one attachment means. For example, the at least one attachment means may comprise a pair of latch attachments 110 as described in relation to FIG. 5, for example wherein the latch attachments 110 are coupled to the upper end of each side bar 902A and 902B, and are configured to couple to the upper rear corner castings of the intermodal container 600. The weight of the container 100 on the base frame 904 may also act to secure the container attachment 900 relative to the container 600.

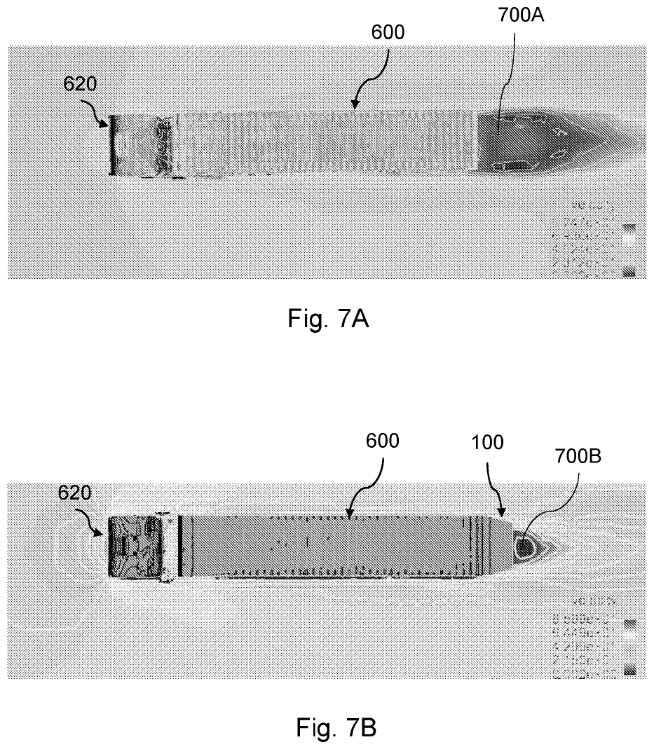

FIG. 7A shows an example fluid dynamics model of a typical tractor (or “truck”) 620 and intermodal container 600. By contrast, FIG. 7B shows an example computation fluid dynamics model of the typical tractor 620 and intermodal container 600 of FIG. 7A, additionally comprising the intermodal container attachment 100 of FIGS. 1 to 3. FIG. 7B illustrates that the intermodal container attachment 100 results in a reduction in drag compared to the tractor 620 and container 600 of FIG. 7A alone.

As shown in FIG. 7A, the rear end of the intermodal container 600 (i.e., the end furthest from the tractor 620) causes a large turbulent wake 700A behind the container 600 which creates considerable drag. Estimates suggest that up to 65% of the drag associated with the vehicle as a whole is created in this area at the rear of the container 600 at highway speeds.

As illustrated by FIG. 7B, the turbulent wake 700B is significantly reduced relative to FIG. 7A and model predicts an expected reduction in drag of up to 16% when the container 600 is coupled to the intermodal container attachment 100. This may equate to a fuel saving of between 8% and 10%.

Whilst the example intermodal container attachment 100 described above is described in relation to attachment to an intermodal container for transit via road, for example via a trailer and tractor, the skilled person will understand that the intermodal container attachment 100 described herein may also be suitable for attachment to an intermodal container for transit via rail, for example via a wagon and train unit. In such examples, the attachment portions are configured to reversibly couple to the intermodal container such that the aerodynamic panels are configured to be arranged adjacent to a first surface of the intermodal container, wherein the intermodal container is configured to couple a train unit, and wherein the rear surface of the intermodal container is configured to be a surface of the intermodal container situated furthest away from the train unit. Preferably, each intermodal container is configured to couple a train unit via a wagon. Furthermore, the upper panel is configured to be situated furthest away from the railway tracks in use, and the lower panel is configured to be situated closest to the railway tracks in use. Where a train unit is coupled to a plurality of intermodal containers, for example via a plurality of wagons wherein each wagon is coupled to an intermodal container, the intermodal container attachment may be coupled to the plurality of intermodal containers, or solely the rear intermodal container, wherein the “rear” intermodal container is defined as the final intermodal container relative to the direction of travel.

It will be appreciated from the discussion above that the embodiments shown in the figures are merely exemplary, and include features which may be generalised, removed or replaced as described herein and as set out in the claims.

In the context of the present disclosure other examples and variations of the apparatus and methods described herein will be apparent to a person of skill in the art.

1. An intermodal container attachment for reducing drag of an intermodal container when coupled to a tractor unit, comprising:
at least one aerodynamic panel; and
at least one attachment portion coupled to the at least one aerodynamic panel, wherein the at least one attachment portion is configured to reversibly couple to an intermodal container such that the at least one aerodynamic panel is configured to be arranged adjacent to a first surface of the intermodal container, wherein the intermodal container is configured to couple a tractor unit, and wherein the first surface of the intermodal container is configured to be a surface of the intermodal container situated furthest away from the tractor unit; and
wherein the at least one aerodynamic panel is configured to be arranged at an acute angle relative to the first surface of the intermodal container when the attachment portion is coupled to the intermodal container.

2. The intermodal container attachment according to claim 1 wherein the at least one aerodynamic panel comprises:
a pair of opposing side panels; and
an upper panel, coupled to a first end of each of the pair of opposing side panels, wherein the first end of each of the pair of opposing side panels is configured to be situated furthest away from a road surface in use;
wherein the pair of opposing side panels and the upper panel are arranged to provide a tapered structure, wherein the upper panel and the pair of opposing side panels are each configured to be arranged at an acute angle relative to the first surface of the intermodal container.

3. The intermodal container attachment according to claim 2 wherein the at least one aerodynamic panel further comprises a lower panel, wherein the lower panel is coupled to a second end of the pair of opposing side panels, wherein the second end of each of the pair of opposing side panels is configured to be situated closest to the road surface in use.

4. The intermodal container attachment according to claim 3 wherein the pair of opposing side panels, the upper panel, and the lower panel are arranged to provide a tapered structure,
wherein the tapered structure forms a frustrum of a square-based pyramid.

5. The intermodal container attachment according to claim 1 wherein the at least one aerodynamic panel is configured to be transitioned between an aerodynamic configuration and a stored configuration, wherein the at least one aerodynamic panel is configured to be arranged at an acute angle relative to the first surface of the intermodal container in the aerodynamic configuration.

6. The intermodal container attachment according to claim 5 wherein the at least one aerodynamic panel is configured to be arranged substantially parallel relative to the first surface of the intermodal container in the stored configuration.

7. The intermodal container attachment according to claim 6 comprising at least one hinge, wherein each hinge is coupled to an aerodynamic panel such that each aerodynamic panel is configured to be transitioned between the aerodynamic configuration and the stored configuration via the respective hinge.

8. The intermodal container attachment according to claim 5 wherein the at least one aerodynamic panel is reversibly inflatable, wherein the at least one aerodynamic panel is configured to be inflated in the aerodynamic configuration, and wherein the at least one aerodynamic panel is configured to be deflated in the stored configuration.

9. The intermodal container attachment according to claim 8 further comprising a pump configured to inflate the at least one inflatable aerodynamic panel.

10. The intermodal container attachment according to claim 1 wherein the at least one attachment portion is configured to couple to a corner casting adjacent to the first surface of the intermodal container.

11. The intermodal container attachment according to claim 1 wherein the at least one attachment portion comprises a hook portion configured to engage with a corner casting of the intermodal container.

12. The intermodal container attachment according to claim 1 wherein the at least
one attachment portion comprises a latch portion configured to engage with a corner casting of the intermodal container.

13. The intermodal container attachment according to claim 1 wherein the intermodal container attachment is configured to be coupled to a skeletal trailer for attachment to an intermodal container.

14. A skeletal trailer for transporting an intermodal container comprising: a chassis; and
an intermodal container attachment according to claim 13;
wherein the intermodal container attachment is coupled to the chassis of the skeletal trailer.

15. The skeletal trailer according to claim 14 wherein the intermodal container attachment is arranged at a distal end of the chassis, wherein the distal end is configured to be an end situated furthest away from a tractor unit, wherein the skeletal trailer is configured to couple to the tractor unit.

16. The skeletal trailer according to claim 14 comprising an actuation means configured to transition the intermodal container attachment between a coupled configuration and an uncoupled configuration, wherein the intermodal container attachment is configured to be coupled to an intermodal container in the coupled configuration, and wherein the intermodal container attachment is configured to be uncoupled from an intermodal container in the uncoupled configuration.

17. The skeletal trailer according to claim 16 wherein the actuation means is configured to transition the intermodal container attachment between the coupled configuration and the uncoupled configuration by pivoting the intermodal container attachment relative to the chassis.
